(19) United States
(12) Patent Application Publication
(10) Pub. No.: US 2026/0171864 A1
(43) Pub. Date: Jun. 18, 2026

(54) STATOR FOR ROTARY DEVICE

(71) Applicant: Eaton Intelligent Power Limited, Dublin (IE)

(72) Inventor: Matthew G. FOX, Ceresco, MI (US)

(73) Assignee: Eaton Intelligent Power Limited, Dublin (IE)

(21) Appl. No.: 19/477,190

(22) PCT Filed: Apr. 22, 2024
(86) PCT No.: PCT/IB2024/053921

§ 371 Date: Oct. 21, 2025

Related U.S. Application Data
(60) Provisional application No. 63/497,506, filed on Apr. 21, 2023.

(51) Int. Cl. H02K 5/20; F16C 19/06; F16C 19/18; F16C 33/10; F16C 33/66

(52) U.S. Cl. CPC H02K 5/203; F16C 19/06; F16C 19/186; F16C 33/106; F16C 33/664

(57) ABSTRACT

A stator of a locking differential includes an inner lip recessed into the central opening. The inner lip engages with a bearing race to secure the stator to a gear housing of the locking differential. The stator holds an electromagnetic coil. The stator is shaped to avoid electromagnetic flux pinch points that could limit the amount of electromagnetic force applied to a locking arrangement of the locking differential.

### CROSS-REFERENCE TO RELATED APPLICATION

This application is being filed on Apr. 22, 2024, as a PCT International application and claims the benefit of and priority to U.S. Provisional Application No. 63/497,506 filed on Apr. 21, 2023, the disclosure of which is hereby incorporated herein by reference in its entirety.

### BACKGROUND

Traction modifying locking differentials typically include a gear case defining a gear chamber, and disposed therein, a differential gear set including at least one input pinion gear and a pair of output side gears. Typically, such a “locking differential” includes some sort of locking mechanism to prevent rotation of one of the side gears relative to the gear case, the engagement of the locking mechanism being initiated by some sort of actuator. Transmitting an appropriate input signal to an electromagnetic coil results in a locking member engaging a mating portion associated with the differential side gear disposed. The electromagnetic coil is held by a stator disposed external of the gear case. In certain examples, a bearing race holds the stator to the gear case.

Referring to FIG. 9, an outer periphery 150 of an example bearing race 162 radially supports a stator 160 holding an electromagnetic coil 116 to position the stator 160 at a gear case. The bearing race 162 is secured to the gear case (e.g., using a snap ring). The bearing race 162 includes a finger 152 that protrudes radially outwardly from the outer periphery 150. The stator 160 defines a notch 154 at an axially outer side 132. In certain examples, the notch 154 is disposed at a radially inner corner of the stator 160. The finger 152 of the bearing race 162 extends into the notch 154 to axially retain the stator 160 relative to the gear case.

Magnetic flux density is mapped over the stator 160, bearing race 162, and a portion 120 of an actuation mechanism for the locking member. When the electromagnetic coil 116 is energized, the notch 154 forms a “pinch point” for the magnetic force flowing through the stator 160. For example, the region of the stator 160 extending between the electromagnetic coil 116 and the notch 154 has a magnetic flux density that is higher than the magnetic flux density of a remainder of the stator 160. The magnetic flux limits the amount of magnetic force that can be applied between the stator 160 and the portion 120 of the actuation mechanism, which limits the stopping force of the locking differential 100.

Improvements are desired.

### SUMMARY

In accordance with certain aspects of the disclosure, a rotary device includes a stator that is axially movable relative to a rotatable housing. A bearing race limits the travel of the stator by engaging an inner lip defined by the stator.

In accordance with certain aspects of the disclosure, a rotary device includes a stator with an electromagnet that actuates a locking mechanism of the rotary device. The shape of the stator limits the magnetic flux density of the stator to less than 2 Tesla.

In certain implementations, the stator defines a central opening extending between opposite first and second sides of the stator. The stator includes a portion extending radially into the central opening to define an inner lip.

In certain implementations, a thickness of the stator does not decrease from an outer radial end of the stator to an inner radial end of the stator.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a cross-sectional view of an example locking differential configured in accordance with the principles of the present disclosure;

FIG. 2 is a perspective view of an example stator suitable for use with the locking differential of FIG. 1;

FIG. 3 is an opposite perspective view of the stator of FIG. 2;

FIG. 4 is a cross-sectional view of the stator of FIG. 2;

FIG. 5 is an enlarged view of a portion of FIG. 5;

FIG. 6 is an enlarged view of a portion of FIG. 2 with the stator arranged in a first position in which an electromagnetic coil is not energized;

FIG. 7 is an enlarged view of a portion of FIG. 2 with the stator arranged in a second position in which an electromagnetic coil is energized;

FIG. 8 is a map of electromagnetic flux density across the stator of FIGS. 1-7; and

FIG. 9 is a map of electromagnetic flux density across a conventional stator.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

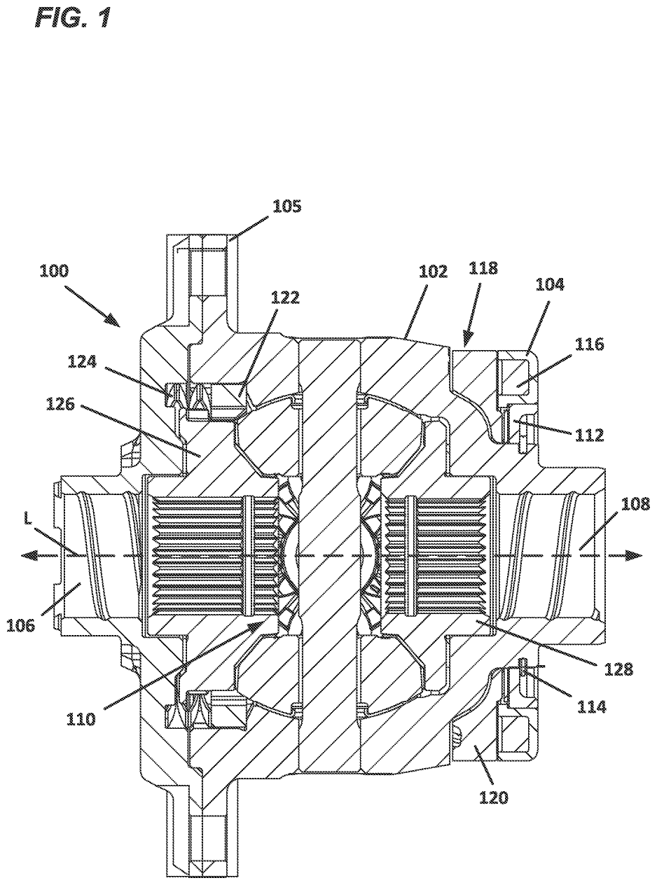

A locking differential 100 for a vehicle shown in FIG. 1 includes a gear housing 102 (e.g., a gear case and an end cap) configured to rotate about a longitudinal axis L of the housing 102. Torque input to the locking differential 100 can be provided by an input ring gear (not shown) to a flange 105 of the gear housing 102. The gear housing 102 defines annular hub portions 106 and 108 at which left and right axle shafts are coupled. A pair of bearing sets (not shown) disposed at the annular hub portions 106, 108 provide rotational support for the rotating differential device 100 relative to an outer differential housing or “carrier” (also not shown). The rotatable housing 102 defines a gear chamber in which a differential gear set 110 is disposed.

The locking differential 100 can be operated in a locked mode or an unlocked mode. When operated in the locked mode, one or both side gears 126, 128 of the differential gear set 110 are locked against rotation relative to the gear housing 102. When operated in the unlocked mode, the side gears 126, 128 are free to spin relative to the gear housing 102. For example, the side gears 126, 128 may be configured to independently rotate about the longitudinal axis L of the gear housing 102. In some implementations, the locking differential 100 is transitioned between locked and unlocked modes manually by a user. In other implementations, the locking differential 100 is transitioned between locked and unlocked modes automatically (e.g., by a microprocessor of the vehicle based on a sensed operational condition of the vehicle).

The locking differential 100 includes a locking arrangement 118 that can be transitioned between a locking configuration and a non-locking configuration. When disposed in the locking configuration, the locking arrangement 118 inhibits independent rotation of the side gear 126 from the gear housing 102. When disposed in the non-locking configuration, the locking arrangement 118 allows independent rotation of the side gear 126 relative to the gear housing 102.

In certain implementations, the locking arrangement 118 is disposed within the gear housing 102. The locking arrangement 118 includes a generally annular collar member 122 which includes ears extending outwardly from a periphery thereof. When the locking arrangement 118 is in the locking configuration, each of the ears is received within a mating, axially-extending recess defined by the gear housing 102. The ears inhibit rotation of the collar member 122 relative to the gear housing 102, but permit axial movement of the collar member 122 between a locked position and an unlocked position. A biasing member 124 (e.g., one or more wave springs) bias the collar member 122 towards the unlocked position.

The locking arrangement 118 also includes an actuation mechanism to transition the locking arrangement 118 between the locking and unlocking configurations. The actuation mechanism includes actuation member (e.g., pins) extending outwardly from fixed positions at the collar member 122 and through the gear housing 102. The actuation members extend to a ramp plate 120 at an opposite side of the gear housing 102. In certain examples, the ramp plate 120 is disposed external of the gear housing 102. The ramp plate 120 defines a plurality of ramp surfaces-one ramp surface 121 for each actuation member. When the actuation members are disposed at bottoms of the ramp surfaces 121, the biasing member 124 biases the collar member 122 to the unlocked position. When the ramp plate 120 rotates relative to the actuation members, the actuation members ride up the ramp surfaces 121 and thereby axially press the collar member 120 against the bias of the spring 124 to the locked position.

Rotation of the ramp plate 120 relative to the actuation members is controlled by an electromagnet 116 disposed at a stator 104. In certain implementations, the ramp plate 120 is formed of a ferrous metal. When the electromagnet 116 is not energized (i.e., not actuated), the ramp plate 120 is entrained by the actuation members to spin with the gear housing 102. When the electromagnet 116 is energized (i.e., is actuated), the electromagnet 116 retards rotation of the ramp plate 120 relative to the gear housing 102. This slowed rotation of the ramp plate 120 causes the actuation members to slide up the ramp surfaces 121 and transition the collar member 122 to the locked position. In certain implementations, the electromagnetic coil 116 can be energized by a pair of electrical leads (not shown).

Additional details about the functioning of the actuation mechanism of the locking differential 100 of the type described hereinabove are shown in U.S. Pat. Nos. 6,083,134; 6,551,209; and 7,264,569, the disclosures of which are each incorporated herein by reference.

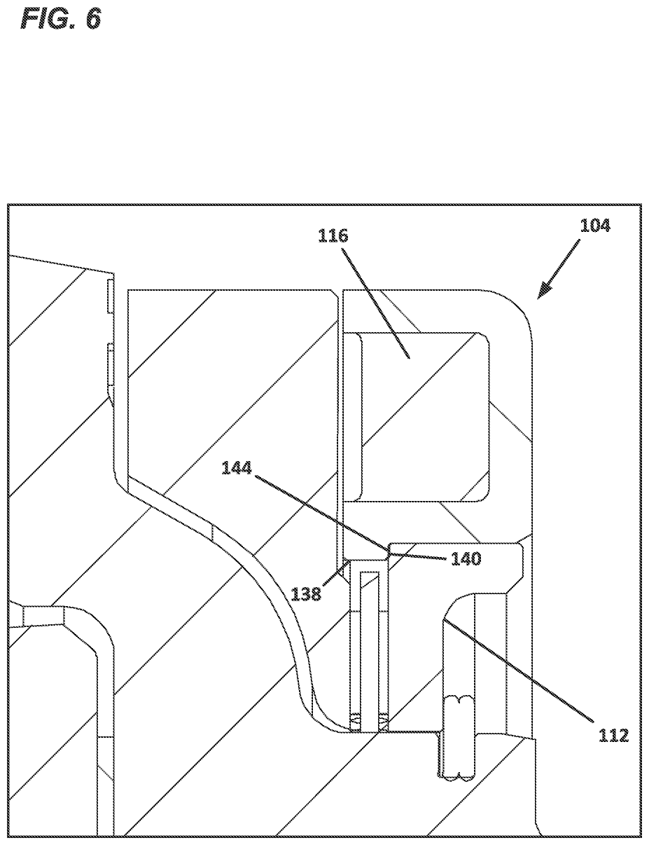

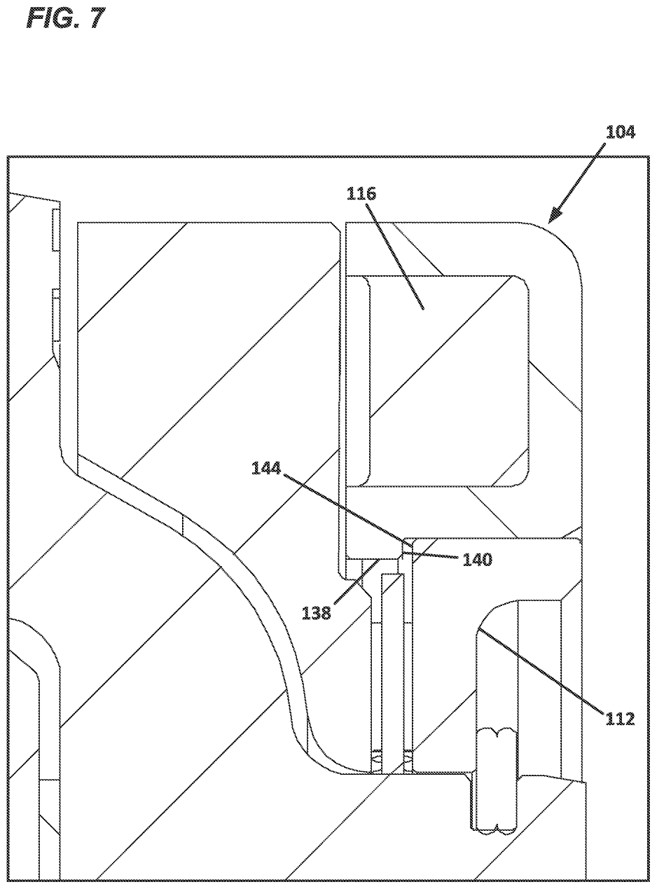

As shown in FIG. 1, the stator 104 holding the electromagnet 116 is secured to the housing 102 using a bearing race 112. The bearing race 112 is mounted to the gear housing 102 in an axially fixed position. For example, the bearing race 112 may be axially fixed to the gear housing 102 using a snap ring 114. Other configurations are possible. An abutment surface 144 of the bearing race 112 aligns with an inner lip 140 of the stator 104 about the longitudinal axis L. In certain implementations, the stator 104 is configured to axially travel along the longitudinal axis L between a first position (e.g., see FIG. 6) and a second position (e.g., see FIG. 7) depending on whether the coil 116 is energized. Abutment between the inner lip 140 of the stator 104 and the abutment surface 144 of the bearing race 112 defines the first position. Abutment between a first axial side of the stator 104 and the ramp plate 120 defines the second position.

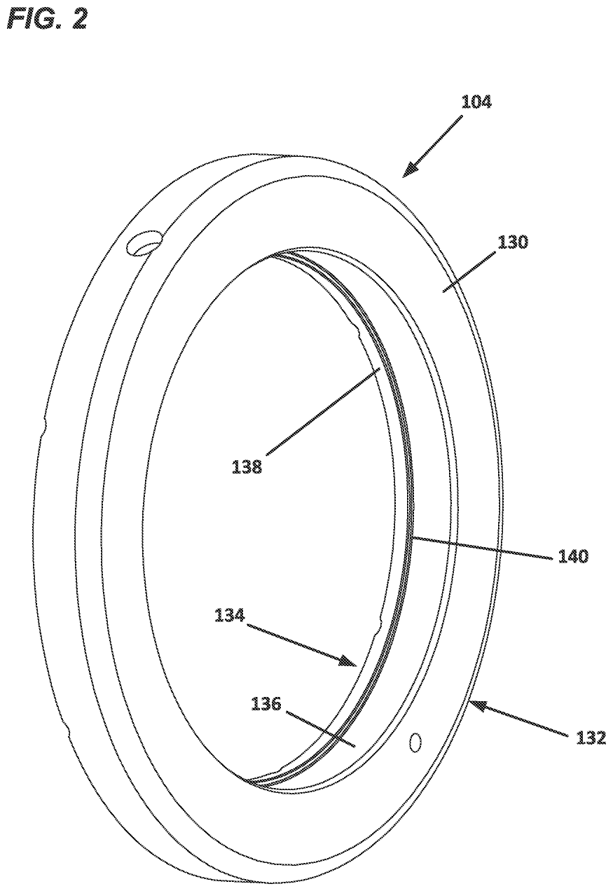

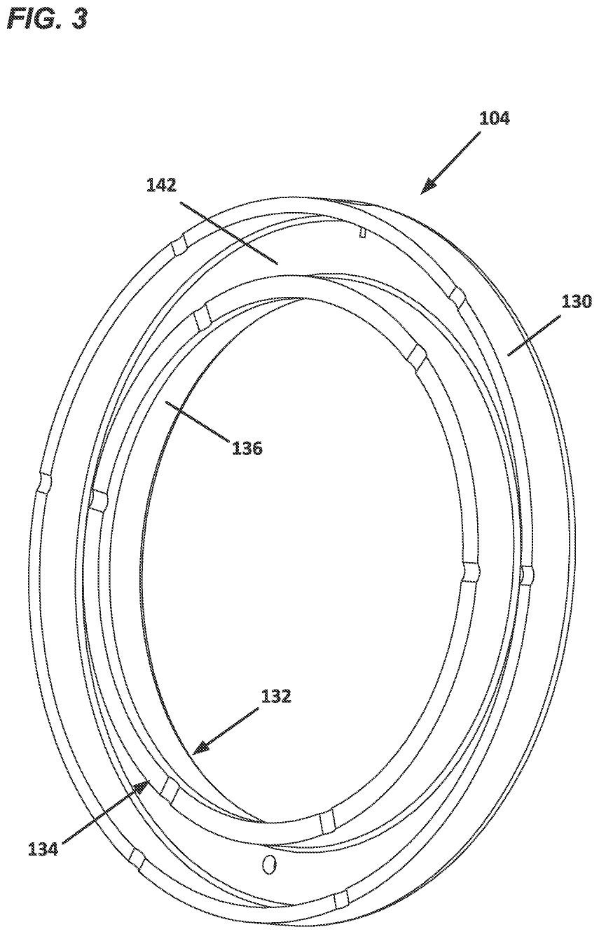

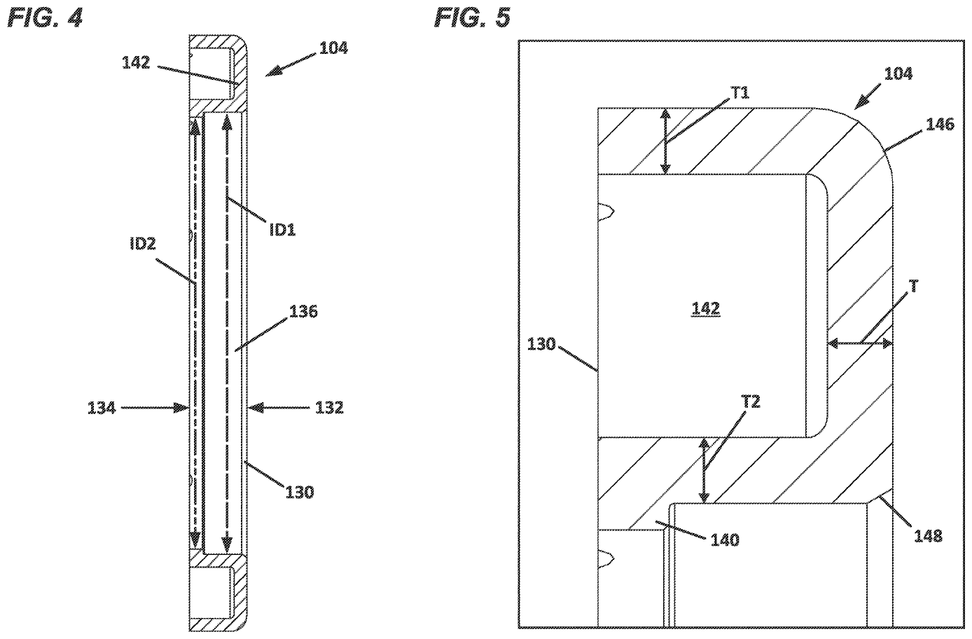

FIGS. 2-5 illustrate one example implementation of a stator 104 suitable for use in the locking differential 100 of FIG. 1. The stator 104 includes a body 130 extending between a first axial side 132 and a second axial side 134. The second axial side 134 defines a cavity (e.g., an annular cavity) 142 in which the coil 116 may be disposed. The body 130 defines a central opening 136 that extends between the first and second axial sides 132, 134. The central opening 136 enables the stator body 130 is be mounted around a portion of the housing 102 (e.g., see FIG. 1).

In accordance with certain aspects of the disclosure, the stator 104 includes a necked-in portion 138 that reduces a size of the central opening 136 at the second axial side 134 of the stator body 130. The necked-in portion 138 defines an inner lip 140 accessible within the central opening 136. In certain implementations, the necked-in portion 138 is disposed at the second axial side 134 of the stator body 130. In certain examples, the necked-in portion 138 is flush with the second axial side 134 of the stator body 104. In certain implementations, the necked-in portion 138 extends along less than half an axial length of the stator body 130. In certain implementations, the necked-in portion 138 extends along no more than a quarter of the axial length of the stator body 130.

In certain implementations, the central opening 136 of the stator body 130 has a first inner diameter ID1 at the first axial side 132 of the body 130 and a second inner diameter ID2 at the second axial side 134 of the body 130. In certain implementations, the second inner diameter ID2 is less than the first inner diameter ID1. The necked-in portion 138 defines the second inner diameter ID2. In some implementations, the first inner diameter ID1 is constant between the inner lip 140 and the first axial side 132 of the stator body 130. In other implementations, the first inner diameter ID1 can vary between the inner lip 140 and the first axial side 132, but always remains larger than the second inner diameter ID2. In certain implementations, the second inner diameter ID2 is constant across the necked-in portion 138.

In certain implementations, the stator body 130 has a U-shaped cross-section (e.g., see FIG. 5). The cavity 142 is defined at a central part of the U while the bottom of the U forms the first axial side 132 of the stator body 130. In certain implementations, a radially outer corner 146 of the U-shaped cross-section is contoured while a radially inner corner 148 of the U-shaped cross-section is angled. In some implementations, the radially inner corner 148 has a square corner. In other implementations, the radially inner corner 148 is chamfered. In certain implementations, the radially inner corner 148 is thicker than the radially outer corner 146.

The stator body 130 has a thickness T (e.g., see FIG. 5). A thickness T2 at the radially inner portion of the U-shaped cross-section is no less than the thickness T1 at the radially outer portion of the U-shaped cross-section. In certain examples, the thickness T2 is greater than the thickness T1. In certain examples, the thickness T of the stator body 130 does not decrease as the stator body 130 extends from the radially outer portion to the radially inner portion.

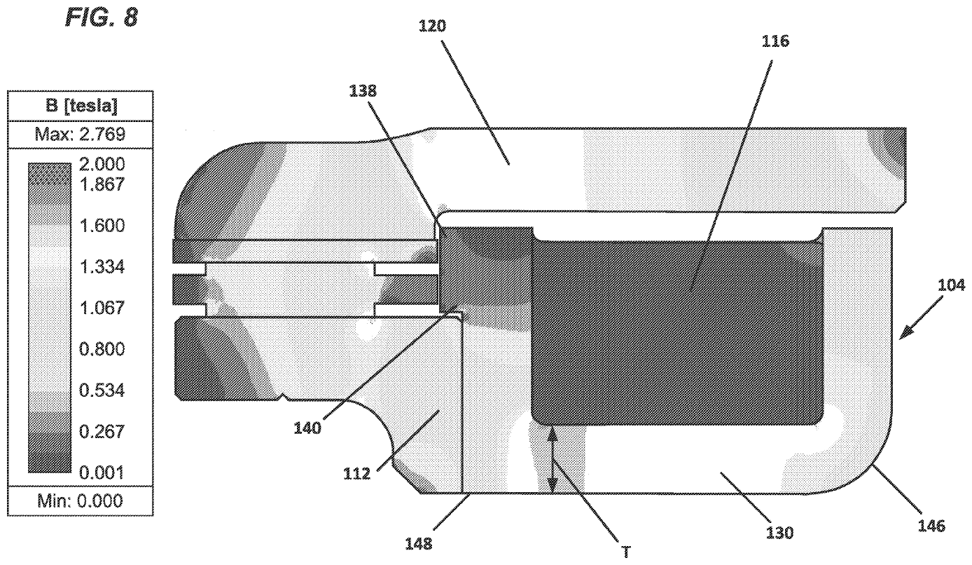

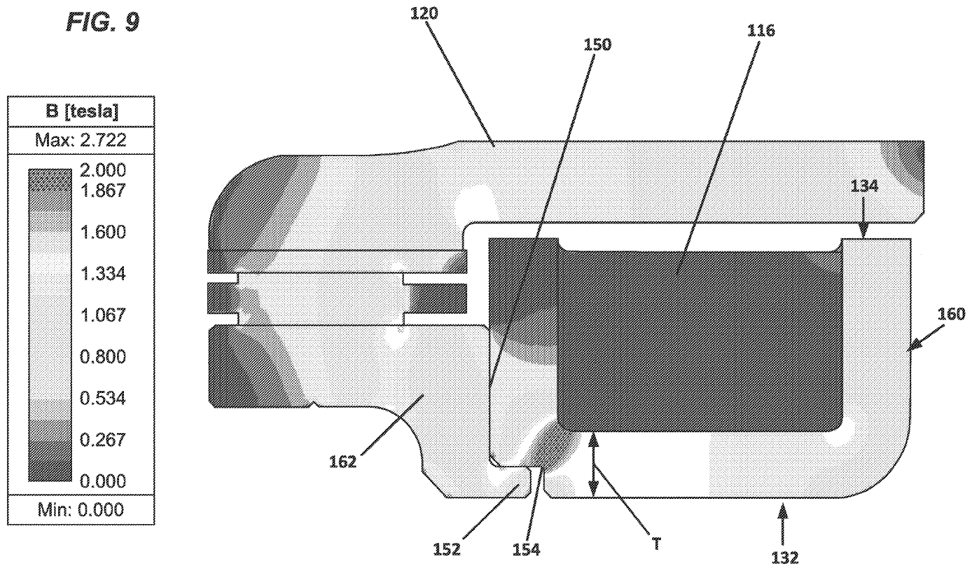

FIG. 8 shows the magnetic flux density of the stator 104 configured in accordance with the principles of the present disclosure. As shown, the stator 104 does not define a notch (e.g., notch 154 of the stator 160 of FIG. 9) to form a pinch point for the electromagnetic flow. Rather, the thickness T of the stator body 130 either is maintained or increases as the body extends radially inwardly and then towards the ramp plate 120. Eliminating the pinch point increases the amount of electromagnetic force that can be applied by the coil 116 to the ramp plate 120. In certain examples, increasing this force may help to more quickly and/or ably counter the rotational momentum of ramp plate 120. In certain examples, increasing this force allows the biasing force of the spring 124 to be increased, which may extend the life of the locking differential 100.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A rotary device comprising:
a rotatable housing;
a stator including an annular housing disposed around a portion of the rotatable housing, the stator defining a central opening through which a portion of the rotatable housing extends when the stator is coupled to the rotatable housing, the stator including an inner lip extending radially into the central opening from a radially inwardly facing periphery of the stator; and
a bearing race mounted around the portion of the rotatable housing at a fixed position, the bearing race being sized to fit within the central opening of the stator so that an outer periphery of the bearing race opposes the radially inwardly facing periphery of the stator, wherein the inner lip of the stator extends radially inwardly past the outer periphery of the bearing race.

2. The rotary device of claim 1, wherein an abutment surface of the bearing race is disposed radially inward of the outer periphery of the bearing race, the abutment surface being aligned with the inner lip of the stator.

3. The rotary device of claim 1, wherein the bearing race has a constant outer diameter.

4. The rotary device of claim 1, wherein the bearing race is devoid of outwardly extending lips.

5. The rotary device of claim 1, wherein the inner lip is disposed at an axial side of the stator.

6. The rotary device of claim 2, further comprising an electromagnet disposed at the stator.

7. The rotary device of claim 6, wherein the stator is configured to axially move relative to the housing from a first position to a second position when the electromagnet is activated, the inner lip of the stator abutting the abutment surface of the bearing race while in the first position, and the inner lip of the stator being spaced from the abutment surface of the bearing race while in the second position.

8. The rotary device of claim 7, wherein the stator is biased to the first position.

9. The rotary device of claim 8, further comprising a lock arrangement mounted about the rotatable housing, the lock arrangement being configured to transition between a locking configuration and a non-locking configuration, the lock arrangement stopping the housing from rotating relative to the stator when disposed in the locking configuration, the lock arrangement enabling rotation of the housing relative to the stator when disposed in the non-locking configuration, the lock arrangement selectively transitioning between the locking and non-locking configurations based on activation of the electromagnet, wherein the stator is biased to the first position via the lock arrangement.

10. The rotary device of claim 6, wherein the stator defines a ring-shaped cavity in which the electromagnet is disposed.

11. The rotary device of claim 1, wherein a thickness of the stator does not decrease from an outer radial end of the stator to an inner radial end of the stator.

12. A rotary device comprising:
a rotatable housing;
a stator including an annular housing disposed around a portion of the rotatable housing, the stator defining a central opening through which a portion of the rotatable housing extends when the stator is coupled to the rotatable housing; and
a bearing race mounted around the portion of the rotatable housing at a fixed position, the bearing race being sized to fit within the central opening of the stator so that an outer periphery of the bearing race opposes a radially inwardly facing periphery of the stator, wherein a thickness of the stator does not decrease as the stator extends radially inwardly towards the outer periphery of the bearing race.

13. The rotary device of claim 12, wherein an axial engagement between the bearing race and the stator is located radially inward of the outer periphery of the bearing race.

14. The rotary device of claim 12, wherein the bearing race has a constant outer diameter.

15. The rotary device of claim 12, wherein the bearing race is devoid of outwardly extending lips.

16. The rotary device of claim 12, wherein an entirety of the stator has a magnetic flux density of less than 2 tesla.

17. The rotary device of claim 12, wherein a first side of the stator is devoid of concave surfaces.

18. The rotary device of claim 12, wherein a diameter of the central opening at a second side of the stator is less than a diameter of the central opening at a first side of the stator.

19. A rotary device comprising:
a rotatable housing;
a stator including an annular housing disposed around a portion of the rotatable housing, the stator defining a central opening through which a portion of the rotatable housing extends when the stator is coupled to the rotatable housing, the central opening extending between opposite first and second sides of the stator the stator, the stator including a portion extending radially into the central opening at the second side to define an inner lip;
a bearing race mounted around the portion of the rotatable housing at a fixed position, the bearing race being sized to fit within the central opening of the stator so that an abutment surface of the bearing race opposes the inner lip of the stator to hold the stator to the rotatable housing.

20. The rotary device of claim 19, wherein the rotatable housing includes a differential case.
